(19) United States
(12) Patent Application Publication
(10) Pub. No.: US 2006/0218324 A1
(43) Pub. Date: Sep. 28, 2006

(54) Systems and methods for flexible data transfers in SDIO and/or MMC

(75) Inventor: Fernando A. Zayas, Loveland, CO (US)

Correspondence Address: FLIESLER MEYER, LLP, FOUR EMBARCADERO CENTER, SUITE 400, SAN FRANCISCO, CA, 94111, US

(73) Assignee: Matsushita Electrical Industrial Co., Ltd, Osaka (JP)

(21) Appl. No.: 11/089,967

(22) Filed: Mar. 25, 2005

(51) Int. Cl. G06F 13/38

(52) U.S. Cl. 710/65

(57) ABSTRACT

The data communication protocols between a host and a device, such as SDIO and MMC, have been extended to include devices using embedded/external/portable HDD in addition to SD Memory Card and Multimedia Card. Instead of allowing only the host to unilaterally decide the data transfer size, embodiments of the present invention offer improvements over various ways data can be transferred under SDIO and MMC by allowing the host and the device to negotiate a data transfer size that both sides agrees upon similar to a hand-shaking protocol. This description is not intended to be a complete description of, or limit the scope of, the invention. Other features, aspects, and objects of the invention can be obtained from a review of the specification, the figures, and the claims.

### INCORPORATION BY REFERENCE

This application is related to the following publications which are hereby incorporated by reference in their entireties:

U.S. Patent Application No. 2004/0202015, entitled “SDIO Card Development System,” by Tai et al. filed Jan. 20, 2004.

“Understanding Secure Digital I/O Performance in Systems and Cards,” by Seung Yi et al, published Mar. 15, 2004.

“SD Input/Output (SDIO) Card Specification,” Version 1.00, by SD Association, published October, 2001.

### FIELD OF THE INVENTION

The present invention relates to data communication between an appliance and a storage device.

### BACKGROUND

The proliferation of feature-rich mobile devices with ever-increasing processing capabilities has created a desire by consumers who increasingly demand for expansion of options to increase capacity (storage) or capabilities (features). As mobile devices become more powerful, the line between a single function consumer electronic device and a more general computing device also becomes blurred as demands grow for thinner and lighter devices via the latest I/O expansion technologies. Consequently, the expansion of storage devices starting with memory storage in the form of memory cards utilizing low cost NAND flash technology, such as Secure Digital (SD) Memory and Multimedia Memory Card (MMC), has now extended to (external/portable) hard disk drives (HDD).

### BRIEF DESCRIPTION OF THE DRAWINGS

FIG. 1 is a functional diagram showing components of a host and a card in accordance with embodiments of the present invention.

FIG. 2 is a diagram showing an exemplary MMC and SD memory card.

FIG. 3 is a is a functional diagram showing components of a hard disk drive that can be used in accordance with embodiments of the present invention.

FIG. 4 shows a flow chart that can be used for flexible data communication between the host and the HDD in accordance with the present invention.

### DETAILED DESCRIPTION

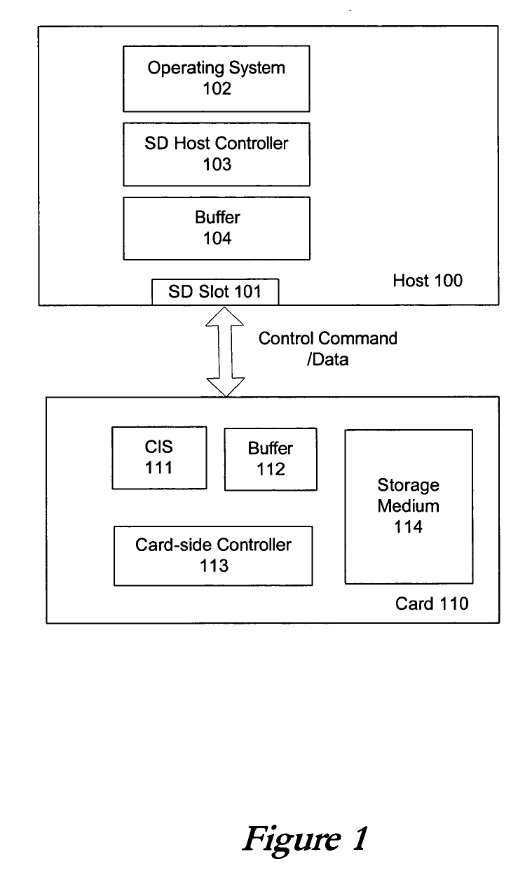

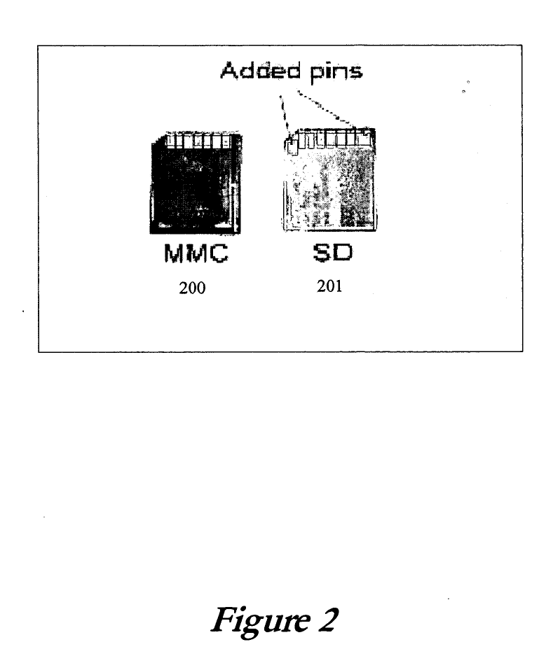

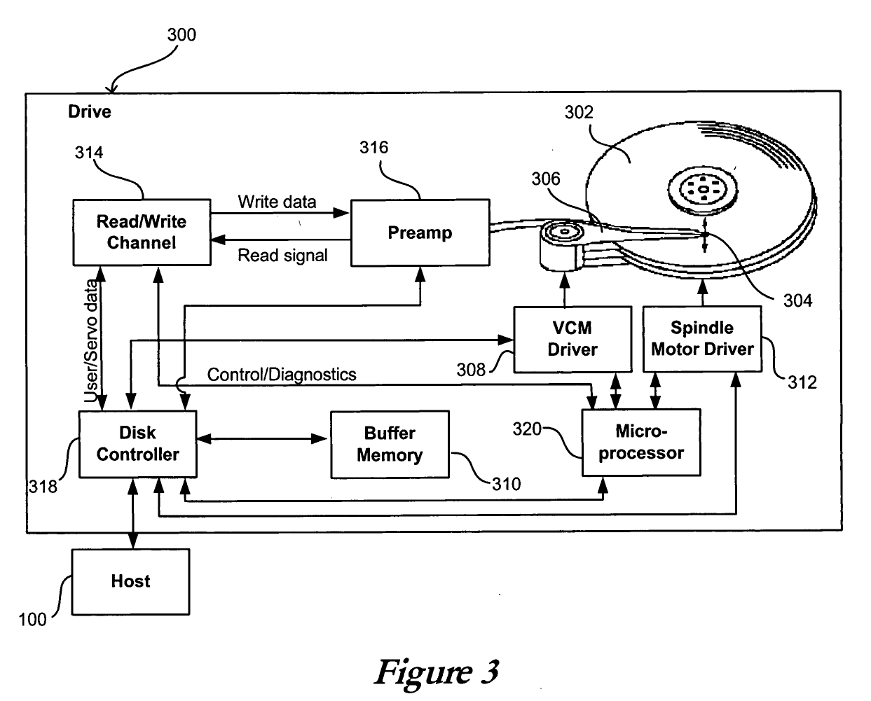

The expansion of the mobile devices demands the standardization of I/O expansion in mobile devices. These mobile devices include, but are not limited to, digital cameras, personal digital assistants (PDA), smart phones, personal computers (PC), laptop/desktop, digital video devices, and portable audio devices, and will be referred to collectively as “host (device or appliance)” 100 in FIG. 1. Previously I/O expansion in mobile devices consisted of proprietary hardware/software interfaces, typically only available to the specific manufacturer and in many cases to a specific device model. Soon afterwards, a generation of devices offered a relatively painless way to incorporate PCMCIA standards to a more mobile-friendly form factor. Card-shaped peripherals are referred to simply as “cards” 110 in FIG. 1, which may include but are not limited to, Multimedia Memory Card (MMC) 200 and SD Memory Card 201 and as shown in FIG. 2, although they may now also include external/portable HDDs as shown later in FIG. 3.

At present, there are two international standards for SD-related devices: (1) the SD memory standard for memory devices and, (2) the SDIO standard for input/output (SDIO) devices, which is an extension of the SD memory card standard and covers input/output (I/O) functions as well as memory functions. Introduced in the later part of 2001, SDIO is an evolutionary offshoot of Secure Digital (SD) memory technology offering device manufacturers a convenient way to support memory, I/O cards and HDDs in the same slot 101. Based on similar electronics and mechanical features borrowed from the original SD memory card specification, SDIO extends the specification to meet I/O specific requirements in terms of power, plug and play, and I/O commands and signals. The addition of I/O expansion capability to an SD memory slot can be implemented at minimal incremental cost, largely due to the availability of compatible hosts.

Secure Digital I/O has its roots in Secure Digital Memory Card and Multimedia Memory Card technology. The MMC format was designed as a low pin count, low power, thin profile non-volatile storage card standard. The electrical interface is a simple direct CMOS/TTL logic-drive serial bus based on two open synchronous serial protocols: the industry standard Serial Peripheral Interface (SPI) and the new Multimedia Card native interface. MMC cards must support both protocols. The intent for having both protocols was to initially design card readers and mobile devices using preexisting off-the-shelf controllers supporting SPI mode. SPI however is a non-optimal implementation as many SPI controllers are limited in speed (˜2-8 MHz) and capability (e.g. no hardware CRC generation). SPI lacks any built-in data read/write flow control and requires additional software to manage simple data transfers. The MMC native interface solves many of these problems by requiring controllers to have built-in CRC generation and data flow control (read start and write acknowledgement bits). The data rate was increased to support clock rates up to 20 MHz, translating into an effective transfer bit rate of 20 Mb/sec. MMC in SPI and native modes use 7 pins and the SPI signals are shared with the native signals. A device can be placed in SPI mode when a special command is issued while the SPI chip select pin signal is driven low.

The Secure Digital I/O standard extends the SD specification to also support I/O peripherals such as bar code scanners, cameras, wireless adapters, GPS modules, and now laptops/notebooks that can be connected to external/portable HDDs. Secure digital I/O and SD Memory cards still support the SPI 1-bit native electrical interfaces, but adds a higher performance 4-bit interface at 25 MHz. This effectively provides 100 Mb/sec transfer rates. Secure Digital I/O and Memory cards are slightly thicker and provide a mechanical write protect switch. SD I/O and Memory card pins share the same 7 pins with MMC cards with the addition of 2 pins to support the 4-bit interface. SD and MMC cards may use a single card slot that supports both pin arrangements. SD I/O and Memory cards can be used in systems with legacy SPI controllers, however they will operate with lower performance. Software handles the differences in the use of each card type.

The SDIO standard may use the same 9-pin slot connector 101 and slot mechanics as Secure Digital Memory format and defines new I/O signaling protocols over existing pins. The SDIO card form factor allows for an extended region to house electronics, RF components, camera lens assemblies, or connectors/antennas. Fundamentally SDIO use the same transport electrical interface, SPI or SD native with the addition of a few new I/O specific commands and signaling mechanisms. To meet the requirements of asynchronous signaling, the standard introduces I/O signaling for Interrupts and data read suspending (Read/Wait). The SDIO standard contains simple, elementary changes allowing existing SD/MMC controllers to be retrofitted into functional SDIO controllers with some “acceptable” limitations. SDIO defines the same SD base clock rate of 25 MHz and uses 1 or 4 data pins. SDIO also defines a low speed card type that uses a 400 KHz clock and a fixed 1-bit mode of operation (4-bit is optional). SDIO bus topology is similar to SD and many of the signals can be bussed, however due to complexities that interrupt signaling, read wait protocol and I/O clock matching introduce, it is highly recommended that the SDIO card slots be used in a point-to-point topology.

SDIO may adopt a “plug and play” architecture with methods for an operating system 102 on the host 100 to load appropriate control software based on information located in the common register set or Card Information Structure (CIS) 111 on the card 110. The CIS is a non-volatile memory region, accessible byte-wide, containing card or function specific meta-data. Each device has a common CIS along with one function specific CIS for each function on the card. A plug and play manager may be interested in the common CIS for device class, manufacturer ID, or power information, while a function driver may be interested in the function CIS for application specific parameters (i.e. MAC address, function capabilities). Control software can also be loaded into non-volatile memory on the card (beyond the CIS), however due to the different operating systems that a card may encounter, this feature is rarely, if ever, used. SDIO defines standard device classes that expose a known register set and card behavior for control software (drivers). An operating system can support standard devices from a range of card manufacturers using a single class driver.

The major functions provided by the control software may include but are not limited to the following: (1) configuration of the SDIO host (i.e., configuring the SDIO host for 1-bit and 4-bit modes, time-out modes, and configuring data length modes); (2) initialization of the connection between the SDIO host and the target SDIO card (i.e., recognizing card type such as a SD memory card or an external/portable HDD) and interpreting commands such as CMD0, CMD5, ACMD41, CMD2, CMD3, etc.; (3) setting of SDIO host commands such as CMD52, CMD53, etc. and transmission of these commands to the target SDIO device; (4) monitoring of responses (i.e., response signals) from the target SDIO card to the host commands from the SDIO host; (5) outputting of communication logs regarding communications (i.e., generating and outputting a trace report or transaction record) between the SDIO host and the target SDIO card; and (6) testing on stress between the SDIO host and the target SDIO device (i.e., multiple transfer testing on a plurality of commands).

An SDIO host controller 103 transforms software SD command requests into an SD or SPI bit stream to the CIS of the target card. The host controller issues start and stop bits (framing), drives the clock and in most implementations (except SPI) a hardware generated check code follows commands and/or data. The host controller may also use buffers 104 to accommodate incoming responses and/or data frames from target cards. Aside from the SD clock rate, host performance can be affected by the modes in which data is transferred (Programmed I/O or Direct Memory Access) and the number of interrupts required per transaction.

Programmed I/O requires bus data to flow through the processor onto the controller through a set of registers (i.e. a Data port). A data port may be a First-In-First-Out (FIFO) allowing the processor to rapidly load data and wait for the controller to complete the transfer. The size of the FIFO can greatly impact programmed I/O performance since it effectively determines the number of interrupts for each transaction. A FIFO empty or full interrupt requires attention from the processor's interrupt service routine to reload or drain the FIFOs. A system should minimally support a 512-byte FIFO size for optimal SD card performance, which translates into 1 interrupt per block in a multi-block data transfer. The consequence of programmed I/O is more apparent when trying to fully utilize the available SD bus bandwidth. Each time a FIFO becomes full or empty the SD bus is effectively paused until the interrupt routine can reload or drain the FIFO. In most designs as soon as the FIFO is filled with at least 1 byte, the transfer can continue immediately. Increasingly faster processors and the use of real time OS are reducing/limiting interrupt latency times making this overhead negligible in comparison to the SD transfer time.

Direct memory access (DMA) can reduce the need for internal FIFO buffers as system memory can be used directly in the transfer. This can greatly reduce the number of interrupts per transfer as the DMA controller can transfer the entire data payload autonomously. DMA can be implemented using a common buffer approach, essentially a fixed size contiguous block of memory for DMA use, or through a scatter-gather approach using scattered memory pages mapped into a virtual memory system. The later requires the fewest number of interrupts but is the most complex to implement in terms of software and hardware. DMA controllers are complex and many system-on-chip designs are limited in their use of DMA. A host controller can implement its own bus mastering DMA (i.e. PCI Local Bus) or require a discrete multi-channel DMA controller to shuttle data to and from main memory to an internal or external bus (internal SoC bus).

A card may typically include a buffer 112 to store data ready for read/write by the host, as well as a storage medium 114 to permanently store the data after the read/write operation is complete. Such storage medium can be NAND flash in case of a SD/MMC card, optical disk, laser-recordable disk, or magnetic surfaces of hard disks in case of HDD. In addition, a card may also include an SDIO controller 113 on the card-side that implements functions needed for peripherals to comply with the SDIO standard and to connect to SDIO host devices. The controller processes SD commands and performs translation, wear leveling tasks, and outputs the appropriate read/erase/write commands to the storage medium. It utilizes embedded software stored in, as a non-limiting example, ROM, to perform the complex wear leveling algorithm and bad block handling. Typically a manufacturer uses one controller for many different card sizes as the internal software can determine the storage medium size by some configuration means.

As mentioned earlier, SDIO (as well as MMC) can also be extended to storage devices other than flash memory cards, especially external/portable HDDs. For a non-limiting example, a typical hard disk drive 300, as shown in FIG. 3, includes at least one magnetic disk 302 capable of storing information on at least one of the surfaces of the disk. A closed-loop servo system can be used to move an actuator arm 306 and data head 304 over the surface of the disk, such that information can be written to, and read from, the surface of the disk. The closed-loop servo system can contain, for example, a voice coil motor driver 308 to drive current through a voice coil motor (not shown) in order to drive the actuator arm, a spindle motor driver 312 to drive current through a spindle motor (not shown) in order to rotate the disk(s), a microprocessor 320 to control the motors, and a disk controller 318 to transfer information between the microprocessor, buffer memory 310, read channel 314, and a host 100. A host can be any device, apparatus, or system capable of utilizing the data storage device, such as a personal computer or Web server or consumer electronics device. The drive can contain at least one processor, or microprocessor 320, that can process information for the disk controller 318, read/write channel 314, VCM driver 308, or spindle driver 312. The microprocessor can also include a servo controller, which can exist as an algorithm resident in the microprocessor 320. The disk controller 318, which can store information in buffer memory 310 resident in the drive, can also provide user data to a read/write channel 314, which can send data signals to a current amplifier or preamp 316 to be written to the disk(s) 302, and can send servo and/or user data signals back to the disk controller 318. A controller for the data storage device can include the disk controller 318 and/or processor 320. The controller can be on one or multiple chips. In one embodiment, a controller chip contains SRAM while DRAM and FLASH are external to the chip. Other memory arrangements can also be used. In another embodiment, all the electronics shown in FIG. 3 can be located in a single “System on a Chip” (SoC).

HDD can use IDE (Integrated Drive Electronics), also know as ATA (Advanced Technology Attachment), which is a standard electronic interface to communicate with the host. The IDE interface is based on the IBM PC Industry Standard Architecture (ISA) 16-bit bus standard, but it is also used in computers that use other bus standards. Most computers sold today use an enhanced version of IDE called Enhanced Integrated Drive Electronics (EIDE). Even in small appliances, such as cellular phones, the ATA (IDE) interface still exists and is presented to the host appliance over the SDIO or MMC bus.

To the host, a HDD device can be regarded as a R/W memory device that has a fixed set of sectors, which are typically 512 bytes in size. A sector is addressed by logical block address (LBA). The logical blocks (the memory) of a HDD are numbered from 0 to the maximum block number. The management of manufacturing detected media defects is done entirely by the HDD without intervention or knowledge of the host. The logical block memory space is thus error-free in most cases. In rare cases, a block cannot be read because the power was removed from the HDD during a write or the data was written wrong during a shock. Rewriting the block will correct these problems and reading after writing will confirm these problems did not occur.

A read or write operation can be accomplished by writing the ATA task file with the starting LBA, the number of sectors to transfer, and the command opcode. Data related to the command is moved by one or more block data move commands in block/sector sized chunks where the sector size typically matches the block size. In other words, when the block data move command moves data, it moves data in both sector units and block units. Upon completion of the command, the task file tells the host if the command succeeded or not.

When a HDD is plugged into a SD slot originally designed for SD cards, the host may communicate with the HDD that speaks ATA commands by using SDIO to transport ATA data and commands between the host and HDD (In some embodiments, the HDD can be embedded in the host appliance with the SDIO interface not externally visible). In other words, the SDIO standard can be used as a “pipe” carrying ATA protocols so that the host and the HDD can communicate. Using HDD in place of a flash card enables more efficient and larger volume of storage access utilizing the same physical interfaces.

SDIO may use command opcode such as CMD53 to move data between the card (HDD) and the host. In MMC, similar commands are called CMD56 and CMD61. This command specifies, among other things, the number of blocks of data to move (in the case of an HDD, a block could be a sector of data as previously discussed). Such command typically allows the host to move all the blocks of data for a given ATA command. In addition, it allows the reading or writing of a large number of I/O registers with a single command. Since it is a block mode transfer command, it provides the highest possible transfer rate.

SDIO defines CMD53 in two modes of operation, non-block (byte mode) and block mode and it may choose to use single block (or byte mode) or multi-block mode for data transfers primarily based on application requirements, cost and complexity. Non-block mode or byte mode is just a single block with a limited block payload that can be varied at any time. In byte mode, a single block can be issued with 1-512 bytes at any time. In block mode a system can send a single or multiple blocks with a size of 1-2048 bytes per block. The later mode however requires the programming of the I/O Block size register with the expected bytes per block. The block size is then fixed for each block for the entire duration of the transfer. In systems where partial blocks may be issued, the transfer is broken down into two transfers: one with blocks of the same length and a final block with the remaining bytes. In between these two transactions, the I/O Block size register must be reprogrammed with the remaining size. Data padding in the remaining block, up to the block size, can eliminate the need for separate transactions and reduce overhead.

The difference between a single block 2048-byte transfer versus a multi-block transfer consisting of 4 blocks of 512 bytes each arises from a combination of the host-side controller and the card-side controller design. From a software perspective, there is little difference since they both consist of issuing one CMD53 and transferring the same amount of data (2048 bytes). On the card controller side, the multi-block approach can reduce the card's buffering requirement since each block (512 bytes) requires a write complete acknowledgement. The acknowledgement can delay the host from sending the next block until the card is ready. A single block of 2048 bytes would require the card to minimally buffer the entire 2048 bytes since the card cannot signal the host to “back-off” until the write acknowledgement phase occurs at the end of the block transfer. Most host systems have 500 to 1000 milliseconds timeout delays for write acknowledgement. If a card can process and free buffers within that amount of time then using the multi-block transfer mechanism can reduce card-side buffering requirements. With regard to the host controller, some unforeseen processing overhead may be encountered due to its design. If the host controller FIFO is only 512 bytes, the number of interrupts to load the FIFO will be roughly the same between the two transfer modes. In some host controller designs the usable FIFO space is limited to the block length and is even imposed on multi-block transfers. This limitation would waste most of the space in a 2048-byte FIFO since it requires that the FIFO be reloaded/drained on the transfer of each block-size (in our 512-byte, multi-block example) worth of data. This limitation is present in some real-world controller designs for the sake of simplicity but is not recommended.

The byte mode or multi-block mode data transfer using is CMD53 similar to the data transfer to/from memory. For the byte mode, byte count for this transfer is set in the command, rather than the fixed block size. Thus, the size of the data payload will be in the range of 1-512 bytes. For the block mode, the only difference is that for a fixed block count, the host does not need to stop the transfer, as it will continue until the block count is satisfied. If the block count is set to zero, the operation is identical to the memory mode in that the host must stop the transfer. The host can determine what length to put into a CMD53 by obtaining the length from the header from inside the device or knows itself how large the payload is.

Under many existing block-based data communication approaches, the host may specify the number of blocks to read from/write to the HDD based on the read or write request, pass that transfer size to the ATA task file for a read/write operation, and use this same transfer size in the block transfer command (e.g., CMD53). One deficiency of such approaches is that, the host unilaterally decides how many blocks of data to read/write without feedback from the opposing side. Unlike flash card, which may be willing to accept any number of sectors in a transfer, HDD might not want to take, in case of a write operation initiated by the host, more than it can buffer in its memory at any one time. For example, if the buffer (memory) of the HDD can only store 50 sectors of data while the host wants to transfer 51 sectors, HDD may ask the host not to give more than 50 sectors and put the last sector on hold until the first 50 sectors in the buffer have been processed. In case of a read operation initiated by the host, the HDD may also want to limit the size of transfer to the data available in its buffer before its head could move to another track to retrieve the rest of the data requested. On the other hand, the host may have its own reasons to restrict the size of a transfer under CMD53 to be smaller than what the HDD is ready to provide.

Systems and methods in accordance with various embodiments of the present invention offer an improvement over the various ways data can be moved under SDIO. A combination of features is proposed to SDIO for a more flexible way to move data, which allows the host and HDD to each select a mutually agreed data transfer size that can be less than the full size the opposing side is asking for during a read/write command. Such an approach is similar to a hand-shaking protocol in SDIO format. It provides means for dynamic flow control of data communication when the buffer size of the HDD is unknown. Since MMC and SDIO are so similar in many aspects, the same feature could be added to MMC as well.

In some embodiments of the present invention, the host can use SDIO (or another interface, such as MMC) as the transport layer to communicate with the HDD. After the host sends a SDIO wrapped ATA read/write command to the HDD with a known length of transfer:
A) The HDD can inform the host, via a register readable by CMD52 (in the case of SDIO), that the length of transfer to use should be LESS THAN the entire size of the read or write command.
B) The host may:
   1. issue to the HDD a CMD53 (in the case of SDIO) to read from the. HDD the number of blocks HDD is willing to accept or transfer at this time, and set the size of the transfer in the CMD53 to that number; or
   2. limit the transfer size to be further less than the HDD wants because of the host's own constraints by issuing a CMD53 that can have a block count that may be LESS THAN the size of the CMD53 block count the HDD requested the host use.

In other words, the HDD may tell the host what it would like to transfer, and the host may respond by limiting the number of blocks to be moved by CMD53 to be less than or equal to that transfer length, limiting the size of the transfer for its own reasons. As a non-limiting example, the host may want to write 100 blocks of data while HDD indicates that it can only handle 40 blocks right now. The host may then inform the HDD that it only has 30 blocks handy to provide to HDD and the rest will be provided later. Such an approach is elegant, efficient, and does not require modifications to drivers above the SDIO/MMC transport layer.

In some embodiments, the HDD may provide the host with the number of blocks it would like to transfer in a register apart from the ATA task file. The HDD could just as well provide the information in the SECTOR COUNT register of the ATA task file.

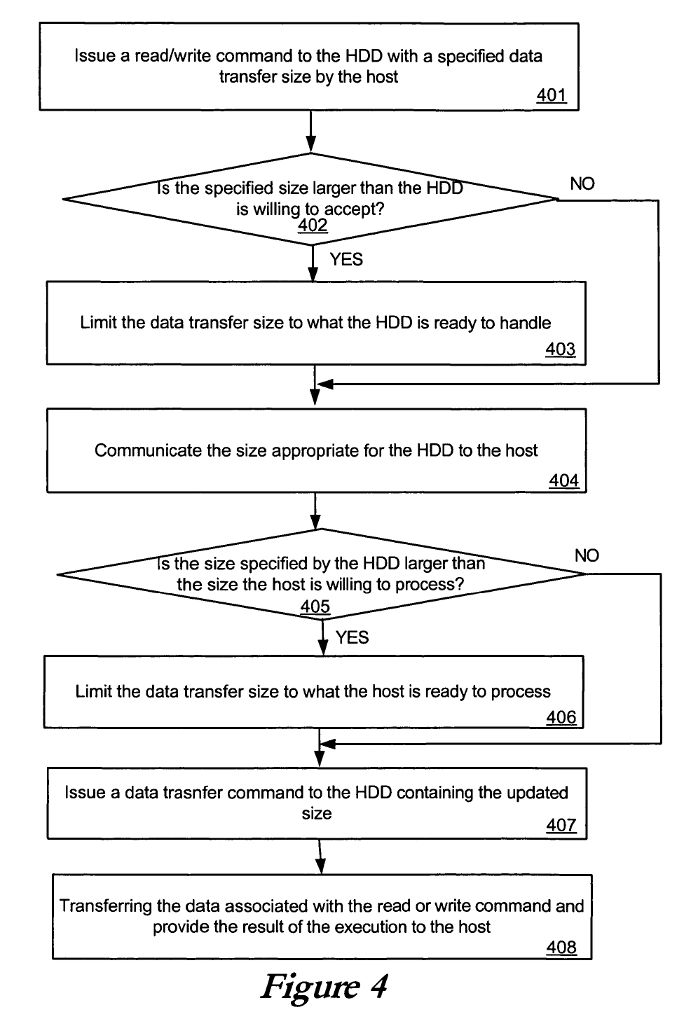

FIG. 4 shows a flow chart that can be used for flexible data communication between the host and the HDD in accordance with the present invention. At step 401, the host may initiate a read/write operation to the HDD in the form of an ATA command sent to an ATA task file via, for a non-limiting example, CMD52 with a specified data transfer size. Upon receiving such command, the HDD may examine at step 402, the availability of its buffer as well as the position of its read/write head among other relevant factors, to determine if the requested data transfer size is larger than what it is willing to accept at this point of time. If the data transfer size requested by the host is larger than the HDD is prepared to handle, the HDD may limit the size of the transfer at step 403 and communicate the new size to the host at step 404. Upon receiving the data transfer size revised by the HDD, the host may compare it to the transfer size it has in mind based on it own reasoning at the time at step 405. If the two sizes are different, the host may revise it again to what it is willing to provide/process at the moment at step 406 and issue a data transfer command such as CMD53 to the HDD containing the negotiated data transfer size at step 407. Finally, the HDD will execute the read/write command, transfer the data associated with the command, and provide the result (feedback) of the execution of the command to the host at step 408.

Although embodiments described herein refer generally to systems having a read/write head that can be used to write bursts on rotating medium (magnetic media), similar advantages can be obtained with other such data storage systems or devices. For example, a laser writing information to an optical media can take advantage of additional passes when writing position information. Any media, or at least any rotating media in a single and/or multi-headed disk drive, upon which information is written, placed, or stored, may be able to take advantage of embodiments of the present invention.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalence.

What is claimed is:

1. A method for flexible data transfer using SDIO and/or MMC protocol, comprising:
issuing a read or write command from a host to a card or embedded device, wherein the command may contain a first size of data to be transferred;
accepting the command and examining the first data transfer size;
informing the host of a second data transfer size determined by the card;
examining the second data transfer size;
issuing a data transfer command from the host to the card, wherein the data transfer command may contain a third size of data to be transferred; and
transferring the data associated with the read or write command and providing the result of the command execution to the host.

2. The method according to claim 1, wherein:
the host can be one of a digital camera, a personal digital assistant (PDA), a smart phone, a personal computer (PC), a laptop/desktop, a digital video device, and a portable audio device.

3. The method according to claim 1, wherein:
the card can be one of: a SD Memory Card, a Multimedia Memory Card and an embedded/external/portable hard disk drive.

4. The method according to claim 1, wherein:
the read or write command can be CMD52.

5. The method according to claim 1, wherein:
the data transfer command can be one of: CMD53, CMD56 and CMD61.

6. The method according to claim 1, wherein:
the first, second, and third data transfer size can be measured in one of bytes, blocks, and sectors.

7. The method according to claim 1, further comprising:
limiting the second data transfer size to be less than the first data transfer size.

8. The method according to claim 1, further comprising:
limiting the second data transfer size to be less than the size of the buffer on the card.

9. The method according to claim 1, further comprising:
limiting the third data transfer size to be less than the second data transfer size.

10. A system for flexible data transfer using SDIO and/or MMC protocol, comprising:
a host comprising at least one of:
a SD slot operable to plug in a card or embedded SD/SDIO interface;
a SD host controller operable to perform at least one of:
issuing a read or write command to the card, wherein the command may contain a first size of data to be transferred;
examining a second data transfer size sent by the card; and
issuing a data transfer command to the card, wherein the data transfer command may contain a third size of data to be transferred; and
said card comprising at least one of:
a storage medium operable to store data;
a buffer operable to store data read from or written to the storage medium during read and/or write operation; and
a card-side controller operable to perform at least one of:
accepting the command and examining the first data transfer size;
informing the host of the second data transfer size preferred by the card; and
transferring the data associated with the read or write command and providing the result of the command execution to the host.

11. The system according to claim 10, wherein:
the host can be one of a digital camera, a personal digital assistant (PDA), a smart phone, a personal computer (PC), a laptop/desktop, a digital video device, and a portable audio device.

12. The system according to claim 10, wherein:
the card can be one of: SD Memory Card, Multimedia Memory Card and embedded/external/portable hard disk drive.

13. The system according to claim 10, wherein:
The storage medium in the card can be one of: a NAND flash memory, a magnetic disk, an optical disk, and a laser-recordable disk.

14. The method according to claim 10, wherein:
the read or write command can be CMD52.

15. The system according to claim 10, wherein:
the data transfer command can be one of: CMD53, CMD56 and CMD61.

16. The system according to claim 10, wherein:
the first, second, and third data transfer size can be measured in one of bytes, blocks, and sectors.

17. The system according to claim 10, wherein:
the card-side controller is further operable to limit the second data transfer size to be less than the first data transfer size.

18. The system according to claim 10, wherein:
the card-side controller is further operable to limit the second data transfer size to be less than the size of the buffer on the card.

19. The system according to claim 10, wherein:
the SD host controller is further operable to limit the third data transfer size to be less than the second data transfer size.

20. A system for flexible data transfer over SDIO and/or MMC protocol, comprising:
means for issuing a read or write command from a host to a card, wherein the command may contain a first size of data to be transferred;
means for accepting the command and examining the first data transfer size;
means for informing the host of a second data transfer size determined by the card;
means for examining the second data transfer size;
means for issuing a data transfer command from the host to the card, wherein the data transfer command may contain a third size of data to be transferred; and
means for transferring the data associated with the read or write command and providing the result of the command execution to the host.
